(19) United States
(12) Patent Application Publication
(10) Pub. No.: US 2002/0170229 A1
(43) Pub. Date: Nov. 21, 2002

(54) System and method for phytomonitoring

(75) Inventors: Yuri Ton, Ashkelon (IL); Michael Kopyt, Beit Shemesh (IL); Nikolai Nilov, Hof Ashkelon (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Phytech Ltd.

(21) Appl. No.: 09/833,716

(22) Filed: Apr. 13, 2001

(51) Int. Cl. A01G 1/00; A01C 1/00

(52) U.S. Cl. 47/1.7

(57) ABSTRACT

A method of assessing a state of a plant is provided. The method includes: (a) collecting data pertaining to at least one plant related parameter over a predetermined time period; and (b) analyzing the data collected over the predetermined time period to thereby identify a trend in the data over at least a portion of the predetermined time period, the trend being indicative of the state of the plant.

### FIELD AND BACKGROUND OF THE INVENTION

The present invention relates to a system and method useful for phytomonitoring and, more particularly, to a system which enables a grower to monitor, assess and optionally control crop growth, either on-site or from a remote location.

Cultivation of commercial crops depends on the monitoring of various parameters of a plant, a field or a greenhouse. Such parameters include, for example a degree of soil or substrate hydration, sun or light radiation, air temperature, humidity and the like. Monitoring of such parameters provides a grower with data with which a crop state can be assessed and corrected, if necessary, by altering climate conditions, irrigation or fertigation in a greenhouse, or by altering irrigation and fertigation in the field.

In the past, growers have relied primarily on intuition and expertise in the assessment of crop related parameters and thus of a crop's condition. This expertise was based mainly on crop and soil inspections and on observing the environmental conditions in which the crop was cultivated.

In recent years, growers have been utilizing systems which employ arrays of precise sensors for measuring temperature, humidity and other related parameters of the environment and/or soil in which the crop is cultivated.

Such automatic monitoring systems were designed to enable growers to automatically track and record changes in a field or greenhouse, down to a level of a single plant.

Such systems can collect sensor data from the soil or atmosphere to generate a plant hydration profile. Such a profile can then be used to assess crop condition and development through daily and seasonal changes. For further details see, for example, Wolf, B. Diagnostic Technique for Improving Crop Production. Haworth Press. P.185-187.

Although theoretically, the use of automated phytomonitoring systems can increase phytomonitoring accuracy, the information obtained from individual plants by such systems cannot be accurately used for predicting the state of an entire crop since parameter values which are obtained from a single plant or it's environment are not always indicative of the state of an entire crop.

As such, although such advanced monitoring systems somewhat improve crop state assessment, the grower still remains a key “factor” in obtaining and assessing information regarding the actual crop conditions during a particular growing period.

Accurate interpretation of information obtained from phytomonitoring systems necessitates years of experience; in addition, such interpretation is oftentimes not sufficient in itself for accurate crop state assessment and thus requires a grower to visually inspect the crop. Such visual inspection is a tedious and time consuming task which is oftentimes performed after a crop is severely under-hydrated or diseased to a point leading to unavoidable crop loss.

In general, there are guidelines commonly used by growers for crop cultivation, however, they are too broad and can not include sufficient specifications regarding native factors such as local climate fluctuations, soil or substrate types, distinct characteristic of fertilizers, pollutants, phenotypic variation of plants, infectious and non-infectious disorders in plants and the like.

In order to overcome some of the limitations described hereinabove, an automated plant-related control methodology was introduced nearly twenty years ago, when an approach referred to as “the speaking plant” attracted the attention of many horticultural experts (Udink ten Cate, A. J., C. P. A. Bot & J. J. Van Dixtorn, 1978. Computer control of greenhouse climates. Acta Horticulturae 87: 265-272). This automated plant-related control methodology was based on the assumption that mathematical models for predicting short and long-term development of plants can be developed based on direct measurements of various plant-related parameters. This approach, however, was not successful due to the difficulty in coordinating short and long-term responses of plants. Moreover, several outstanding experts believe that it is practically impossible to develop sensors that can be used to directly evaluate crop performance (Challa H. and J. C. Bakker, 1995. Synthesis. In: J. C. Bakker, G. P. A. Bot, H. Challa and N. J. Van de Braak (Eds), Greenhouse Climate Control: an integrated approach. Wageningen Pers. Wageningen: 97-100). Further efforts in developing plant-related control devices have been designed and tested. All currently available devices are aimed primarily at assessing the soil or substrate hydration status so as to maintain an accurate irrigation protocol. Such devices provide the grower with numeric information, which is based on a sensor that detects a numeric value of a plant-related parameter, followed by a comparison of the measured value to a single predetermined value. Thus, the only information a grower can obtain is whether the analyzed parameter is higher or lower than the predetermined value.

In addition, since such data is presented to the grower as absolute numerical data it can oftentimes be difficult to perceive and analyze.

Due to he abovementioned limitations of presently available plant monitoring systems, a grower's cultivation policy is still based mainly on visual observations of plants and on periodical diagnoses of plant pathology and nutritional disorders performed by commercial plant analysis laboratories (Wolf B., 1996. Diagnostic techniques for improving crop production, The Haworth Press, NY: 367-368).

There is thus a widely recognized need for, and it would be highly advantageous to have, a system and method enabling accurate and objective crop state assessment devoid of the above limitation.

### SUMMARY OF THE INVENTION

According to one aspect of the present invention there is provided a method of assessing a state of a plant comprising: (a) collecting data pertaining to at least one plant related parameter over a predetermined time period; and (b) analyzing the data collected over the predetermined time period to thereby identify a trend in the data over at least a portion of the predetermined time period, the trend being indicative of the state of the plant.

According to further features in preferred embodiments of the invention described below the method further comprising the step of correlating the trend to an additional trend derived from data collected over the at least a portion of the predetermined time period of another plant related parameter to thereby determine the state of the plant.

According to still further features in preferred embodiments of the invention described below, the method further comprising the step of correlating the trend to at least one environmental parameter data acquired prior to or during the predetermined time period to thereby determine the state of the plant.

According to still further features in the described preferred embodiments the trend represents a positive change in a value of the at least one plant related parameter, a negative change in the value of the at least one plant related parameter, or no change in the value of the at least one plant related parameter over the at least a portion of the predetermined time period.

According to still further features in the described preferred embodiments the method further comprising the step of graphically representing the data pertaining to the at least one plant related parameter over the predetermined time period.

According to still further features in the described preferred embodiments the data pertaining to the at least one plant related parameter is selected from the group consisting of leaf temperature data, flower temperature data, fruit surface temperature data, stem flux relative rate data, stem diameter variation data, fruit growth rate data, leaf CO2 exchange data and the like.

According to still further features in the described preferred embodiments the at least one environmental parameter data is selected from the group consisting of air humidity data, air temperature data, solar radiation data, a boundary diffusion layer resistance data, soil moisture data, and a soil temperature data and the like.

According to still further features in the described preferred embodiments the step of collecting data is effected by at least one sensor positioned on, or in proximity to, the plant.

According to still further features in the described preferred embodiments the step of analyzing the data is effected by a processing unit.

According to another aspect of the present invention there is provided a method of assessing a state of a crop comprising: (a) selecting a first plant, the first plant being representative of the crop; (b) collecting a first set of data pertaining to at least one plant related parameter of the first plant over a predetermined time period; and (c) analyzing the first set of data collected over the predetermined time period to thereby identify a trend in the first set of data over at least a portion of the predetermined time period, the trend being indicative of a state of the first plant and thus the state of the crop.

According to still further features in the described preferred embodiments the method further comprising: (d) selecting a second plant, the second plant being a reference plant to the first plant; (e) collecting a second set of data pertaining to at least one plant related parameter of the second plant over the predetermined time period; and (f) comparing the first set of data and the second set of data to thereby verify that the first plant is representative of the field crop.

According to still further features in the described preferred embodiments the step of selecting the first plant is effected according to at least one selection criterion.

According to still further features in the described preferred embodiments the at least one selection criterion is selected from the group consisting of plant height number of leaves, number and length of stems, number of fruits and fruit size.

According to still further features in the described preferred embodiments the step of selecting the second plant is effected according to the at least one selection criterion.

According to still further features in the described preferred embodiments the method further comprising the step of correlating said trend to an additional trend derived from data pertaining to an additional plant related parameter collected over said predetermined time period.

According to still further features in the described preferred embodiments the method further comprising the step of correlating the trend to at least one environmental parameter data acquired prior to, or during the predetermined time period, to thereby determine the state of the first plant and thus the state of the crop.

According to still further features in the described preferred embodiments the trend represents a positive change in a value of the at least one plant related parameter, a negative change in the value of the at least one plant related parameter, or no change in the value of the at least one plant related parameter over the at least a portion of the predetermined time period.

According to still further features in the described preferred embodiments the data pertaining to the at least one plant related parameter is selected from the group consisting of leaf temperature data, flower temperature data, fruit surface temperature data, stem flux relative rate data, stem diameter variation data, fruit growth rate data, leaf CO2 exchange data and the like.

According to still further features in the described preferred embodiments the at least one environmental data is selected from the group consisting of air humidity data, air temperature data, solar radiation data, a boundary diffusion layer resistance data, soil moisture data, and a soil temperature data and the like.

According to still further features in the described preferred embodiments the step of collecting the first set of data is effected by at least one sensor positioned on, or in proximity to, the first plant.

According to still further features in the described preferred embodiments step (e) is effected by at least one sensor positioned on, or in proximity to, the second plant.

According to still further features in the described preferred embodiments step (c) is effected by processing unit.

According to yet another aspect of the present invention there is provided a system for assessing a state of a plant comprising: (a) at least one sensor positioned on, or in proximity to, the plant, the at least one sensor being for collecting data pertaining to at least one plant related parameter; and (b) a user client being in communication with the at least one sensor, the user client being for receiving and optionally analyzing the data collected from the at least one sensor over a predetermined time period to thereby identify a trend in the data over at least a portion of the predetermined time period, the trend being indicative of the state of the plant.

According to still further features in the described preferred embodiments the communication between the user client and the at least one sensor is effected via a communication network.

According to still further features in the described preferred embodiments the system further comprising a display being for displaying the data collected from the at least one sensor over the predetermined time period.

According to still further features in the described preferred embodiments the system further comprising at least one device being in communication with the at least one user client, the device being for modifying the state of the plant.

According to still further features in the described preferred embodiments the device is selected from the group consisting of an irrigation device, a fertigation device and a climate controller.

According to another aspect of the present invention there is provided a method of assessing the state of a crop comprising: (a) co-cultivating a first plant with a crop of a second plant, the first plant being more sensitive to a change in at least one environmental factor or an infection by a pathogen than the second plant; and (b) monitoring at least one parameter associated with the first plant to thereby assess the state of the crop.

The present invention successfully addresses the shortcomings of the presently known configurations by providing a system and method useful for rapidly assessing the state of a plant or crop thus enabling a grower to maximize crop yield.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a system for monitoring and assessing the state of a plant or crop according to the teachings of the present invention.

FIG. 2 is a diagram illustrating a plant monitoring method according to the teachings of the present invention.

FIG. 3 is a detailed diagram illustrating a plant monitoring method according to the teachings of the present invention.

FIG. 4 illustrates plant sensor positioning according to the teachings of the present invention.

FIG. 5 is a graph illustrating plant stem diameter variation as a function of time; dashed lines represent daily maximum values, which were determined as a predawn maximal value of stem diameter. The daily increment in stem diameter is presented by the difference between two sequential maximums.

FIG. 6 is a graph illustrating plant stem diameter variation and trend evolution as a function of time.

FIG. 7 is a graph illustrating leaf-air temperature difference as a function of air vapor pressure deficit (VPD).

FIGS. 8a-c are graphs illustrating sap flow rate as a function of time at normal water conditions (FIG. 8a), under water stress (FIG. 8b) and under saturating-water stress (FIG. 8c);

FIG. 9 illustrates water movement in a soil-plant-atmosphere system. The various hydration values enable to track the water path and determine plant water status.

FIG. 10 is a graph illustrating air temperature as a function of time; thresholds are indicted by horizontal lines.

FIG. 11 graphically illustrates temperature minus dew point with respect to temperature versus time. Upper line-graph represents air temperature minus dew point temperature while the lower line-graph represents leaf temperature minus dew point temperature.

FIG. 12 is a graph illustrating stem diameter versus time.

FIG. 13 is a graph illustrating fruit diameter versus time.

FIG. 14 is a graph illustrating sap flow rate as a function of vapor pressure deficit.

FIG. 15 graphically illustrates stem diameter versus time (lower line-graph) with respect to sap flow rate versus time (upper line-graph).

### DESCRIPTION OF THE PREFERRED EMBODIMENTS

The present invention is of a system and method which can be used to monitor a state of a plant or crop. Specifically, the present invention can be used to accurately assess the state of the plant or crop without having to resort to a expert interpretation of data collected from the plant or environment.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Although various phytomonitoring systems have been available for more than a decade, data provided by such systems requires further analysis by an experienced grower in order to provide accurate assessment of the state of a crop.

To overcome such limitations, the present inventor has devised a novel phytomonitoring method which can be used to assess the state of a single plant or a crop without having to expertly interpret the results, thus providing even the non-expert horticulturist with an ability to accurately assess the state of a plant or crop.

Thus, according to one aspect of the present invention there is provided a method of assessing a state of a plant. The method is effected by collecting data pertaining to at least one plant related parameter over a predetermined time period and analyzing this data to thereby identify a trend in the data over at least a portion of the predetermined time period.

As used herein, the term “trend” refers to a positive change, negative change or no change in a value of one or more plant related parameters during a time period, or to a change in a relationship between two or more plant related parameters during a time period. A trend according to the present invention serves as an indication of the state of the plant and therefore the crop in which it grown at any given time.

Plant parameter data from which trends can be extracted include, but is not limited to, leaf temperature data, flower temperature data, fruit surface temperature data, stem flux relative rate data, stem diameter variation data, fruit growth rate data, leaf CO₂ exchange data and the like.

Such trends can be assessed individually or they can be inter-correlated to yield a more accurate assessment of a plant state.

The plant related trend or trends can also be correlated with trends extracted from data pertaining to environmental parameter(s), thus enabling to determine the effect of various environmental factors, or the change in an environmental factor, on the state of the plant.

Environmental parameter data from which trends can be extracted include, but is not limited to, air humidity data, air temperature data, solar radiation data, a boundary diffusion layer resistance data, soil moisture data, soil temperature data, vapor pressure deficit, potential evapotranspiration and the like.

In addition to data collected directly from the plant or the environment, the method of the present invention can also extract trends from calculated data pertaining to a plant or environmentally related parameter.

The Table below lists some of the collected/calculated plant and environmental data which can be processed according to the method of the present invention in order to yield trends which are indicative of a plant state.

Various parameters useful for trend extraction

| Data | Values and characteristics |
|---|---|
| Measured environmental data | solar irradiation (global, photosynthetic) |
| | air temperature, |
| | air humidity, |
| | leaf boundary layer diffusion resistance, |
| | wind speed |
| | soil (substratum) temperature, |
| | soil (substratum) moisture. |
| | CO2 concentration |
| calculated environmental related data | thermal time (amount of physiologically active |
| | temperatures), |
| | dew point temperature, |
| | surface wetness duration |
| | amount of light, |
| | water vapor pressure deficit, |
| | potential evapotranspiration. |
| Measured plant related data | leaf temperature, |
| | flower temperature, |
| | fruit surface temperature, |
| | stem flux relative rate, |
| | stem diameter variations, |
| | internode growth rate, |
| | stem growth rate, |
| | fruit growth rate, |
| | CO₂ exchange of leaves. |
| Calculated plant related data | leaf-air temperature difference, |
| | leaf and/or fruit temperature in relation to the dew |
| | point temperature, |
| | stem diameter daily contraction, |
| | daily maximum stem diameter evolution, |
| | daily fruit increment, |
| | plant water stress index, |
| | light curve of photosynthesis, |
| | daily CO₂ balance of leaves. |

The processes of data collection, trend extraction and interpretation and trend inter-correlation are further described in detail in the Examples section which follows.

The evaluation of plant and environmental trends enables a grower to asses the state of a single plant or a crop. Although the methodology of the present invention can be applied to a large number of plants of a single crop, such application is not preferred, since it requires the monitoring of a plurality of plants, which monitoring can be both time consuming and expensive to implement.

Thus, according to another aspect of the present invention there is provided a novel method of assessing a state of a crop.

The method is effected by selecting a plant which is representative of the crop and extracting a trend or trends from the data collected therefrom.

The representative plant can be identical to the crop grown plant or it can be a plant which is more sensitive to a change in at least one environmental parameter (e.g., hydration, temperature or radiation) or pathogen infection than the crop grown plant.

In any case, selection of a representative plant is effected according to one or more criteria including but not limited to plant appearance, plant height, number of leaves, number of fruits, fruit size, and the like.

Preferably, the representative plant is located somewhere in the center of a cultivated unit area. Uniformity of the cultivated unit is determined according to several criteria including, but not limited to, variety of the crop plant, development stage of the crop plant, control facilities, control regime, treatments, and environmental conditions.

Some heterogeneity is allowed since the environmental conditions and control regimens are applied to the growing area as a whole. Individual control regimes cannot ensue from individual characteristics of plants, even if they are available.

A unit area selected can be of an area ranging from several m² to 1-2 hectares or even more depending on the crop grown and the environmental conditions expected (Adams S. R.,Valdes V. M., Hamer P. J. C. and Bailey B. J., 2000. Spatial variation and comparison of yields of tomatoes growm in small experimental compartments with those in large commercial units. Acta Horticulturae 534).

The method according to this aspect of the present invention is further effected by selecting an additional plant and extracting a trend or trends from the data collected therefrom. The additional plant serves as a reference to the representative plant and as such it is preferably selected according to the criteria and considerations described above.

Trends from both the representative and reference plants are then compared to thereby verify the validity of the representative plant. If both plants exhibit similar trends over time, than the representative plant of the crop is considered valid. If, however, trend similarities do not exist, a second reference plant or a second representative plant are selected and trend similarities are retested. As an additional measure, trends from both the representative and control plants can be correlated with trends extracted from environmental data to further verify the relationship between these plants.

Selection and verification of a crop representative plant enables a grower to monitor an entire crop using a single plant. This enables considerable savings in time, data processing and expenses incurred by the equipment used for data collection.

To enable data collection and trend extraction the present invention employs plant and optionally environmental sensor(s) positioned on, or in proximity to, the plant, and a processing unit communicating therewith for processing the sensor collected data.

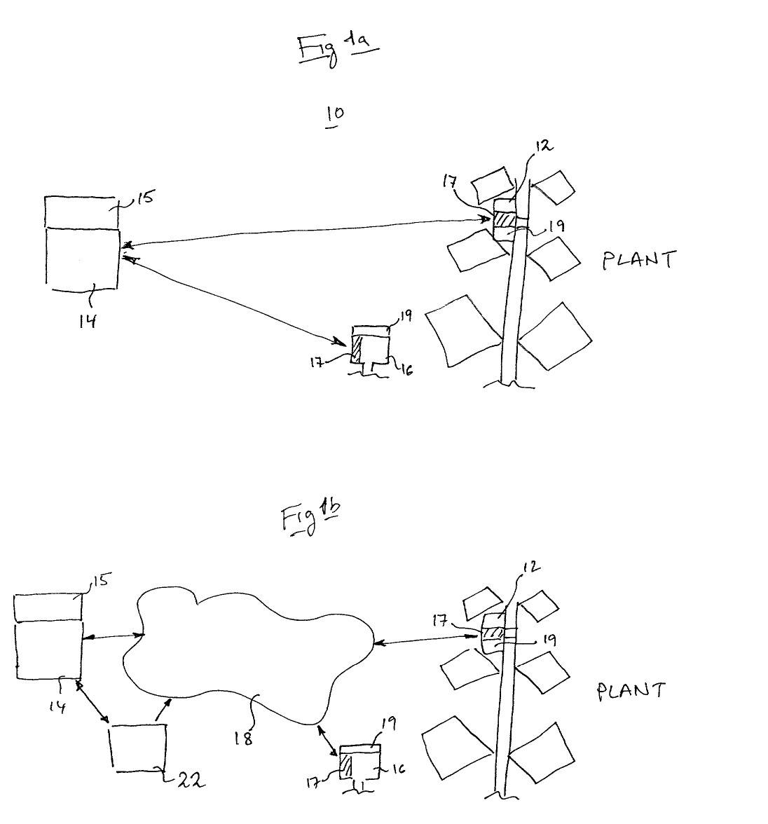

Thus according to another aspect of the present invention, and as shown in FIGS. 1a-b, there is provided a system for assessing a state of a plant which is referred to herein as system 10.

System 10 includes at least one plant sensor 12 which is positioned on, or in proximity to, the plant. Sensor 12 serves for collecting data pertaining to at least one plant related parameter. Examples of plant sensors include, but are not limited to, LT-1 Leaf Temperature Sensor, SF-4 Stem Flux Relative Rate Sensor, SD-5 Stem Diameter Variation Sensor, SD-6 Trunk Diameter Variation Sensors, DE-1 Electronic Dendrometer, SA-2 Stem Auxanometer, FI-3EA Fruit Growth Sensor or other models for smaller fruits like FI-M (medium), FI-S (small), FI-XS(extra-small).

Each of the sensors 12 employed by system 10 are positioned on the plant in accordance with considerations to plant size, canopy size, type of plant, growth environment and the like. The examples section which follows describes in detail plant sensor positioning according to the present invention.

System 10 further includes a user client 14 which is capable of communicating with sensor 12. User client 14 serves for receiving and optionally analyzing the data collected from sensor 12 over a predetermined time period to thereby identify a trend in the data over at least a portion of the predetermined time period; as mentioned hereinabove, such a trend is indicative of the state of the plant.

System 10 preferably further includes a display 15 which serves for displaying the data collected from sensors 12 and 16 to a user.

The data collected is preferably processed by user client and displayed by display 15 as a curve or a graph which enables the user to recognize positive, negative and/or neutral trends (see the Examples section below for further details).

Alternatively or additionally, the data can be displayed as relative numerical values with, for example, 10 indicating a strong positive trend, 1 indicating a strong negative trend and 5 indicating a neutral trend.

The data can also be processed and displayed as a simple color coded image, with a distinctive color assigned to each trend. For example, colors such as green, red and blue can be used to indicate positive, negative and neutral trends (respectively) while the intensity or hue of each color can serve as an indication of trend strength.

As used herein, the phrase “user client” generally refers to a computer and includes, but is not limited to, personal computers (PC) having an operating system such as DOS, Windows, OS/2198 or Linux; Macintosh™ computers; computers having JAVA™-OS as the operating system graphical workstations such as the computers of Sun Microsystems™ and Silicon Graphics™, and other computers having some version of the UNIX operating system such as AIX™ or SOLARIS™ of Sun Microsystems™, or any other known and available operating system; personal digital assistants (PDA), cellular telephones having Internet capabilities (e.g., wireless application protocol, WAP) and Web TVs.

For purposes of this specification, the term “Windows™” includes, but is not limited to, Windows20000™, Windows95™, Windows 3.x ™ in which “x” is an integer such as “1”, Windows NT™, Windows98™, Windows CE™ and any upgraded versions of these operating systems by Microsoft Corp. (USA).

Preferably, system 10 further includes at least one environmental sensor 16 capable of communicating with user client 14. Sensor 16 serves for collecting data pertaining to at least one environmental related parameter. Examples of environmental sensors include, but are not limited to, TIR-4 Total Irradiance Sensor, ATH-2 Air Temperature and Humidity Gauge, BDR-02 Boundary Resistance Sensor, ST-22 Soil Temperature Sensor, SMS-2 Soil Moisture Sensor.

Each of the sensors 16 employed is positioned around the plant in accordance with predetermined considerations. The examples section which follows describes in detail sensors positioning in the environment surrounding the plant.

Sensors 12 and 16 each include a communication port 17 configured for hardwire or wireless communication with user client 14. Communication port 17 serves for relaying sensor data to user client 14 and also optionally for receiving command signals (e.g., on/off, and the like) from user client 14.

Preferably both sensors 12 and 16 include a memory device 19 for storing data collected thereby over time. This allows user client 14 to retrieve data from sensors 12 and 16 periodically rather then continuously.

According to one preferred embodiment of this aspect of the present invention and as specifically shown in FIG. 1a, user client 14 is located in proximity to sensors 12 and 16 (on-site). According to this on-site configuration of system 10, sensors 12 and 16 communicate with user client 14 through a direct hardwire connection or via wireless communication such as that enabled by, for example, a BlueTooth chip or an infra red port.

In an on-site configuration of system 10, user client 14 can be, for example, a mobile hand held device operated by the user in the vicinity of the plant or crop. Alternatively, the functions of user client 14 can be integrated into a plant/environmental sensor or a group of such sensors to thereby provide a plant state-indicator device which is capable of displaying the state of a plant via, for example, a simple numerical display.

System 10 can also be employ a user client 14 which is positioned remote from sensors 12 and 16. In such a case, communication between user client 14 and sensors 12 and 16 is preferably effected via a communication network 18.

Communication network can be a computer, telephone (e.g. cellular) or satellite network or any combination thereof. For example, communication network 18 can be a combination of a cellular network and a computer network (e.g. the Internet).

User client 14 can communicate directly with communication network 16 or alternatively such communication can be mediated through a server 22.

In the latter case, server 22 can be, for example, a Web server capable of processing the sensor data and storing and displaying such data through a Web site maintained thereby. In such a case, a user of user client 14 can view the data collected from the sensors by using a Web browser program operating in user client 14.

As used herein, the term “Web site” is used to refer to at least one Web page, and preferably a plurality of Web pages, virtually connected to form a coherent group of interlinked documents.

As used herein, the term “Web page” refers to any document written in a mark-up language including, but not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator).

As used herein, the phrase “Web browser” or the term “browser” refers to any software application which can display text, graphics, or both, from Web pages on World Wide Web sites. Examples of Web browsers include, Netscape navigator, Internet Explorer, Opera, iCab and the like.

Thus, the present invention enables on-site or remote monitoring of plants or crops. By carefully selecting a plant as a crop representative, and by relaying the sensor data collected therefrom to an operator situated anywhere on the globe, the system of the present invention enables a grower to track large crops grown even in remote locations over extended time periods.

The present invention is particularly advantageous over prior art phytomonitoring systems in that it negates the need for expert data interpretation thus allowing even an inexperienced horticulturist to accurately and consistently assess the state of a plant or crop.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

Several non-invasive sensors were placed on representative crop plants (tomato or bell pepper) in order to collect data pertaining to specific plant related parameters from these plants.

In addition, a set of environmental sensors were placed in the vicinity of each representative plant in order to correlate the plant collected data with environmental collected data.

The data collected from the plant sensors was used to generate a time dependent plot which can be used either alone or in combination with similarly plotted environmental sensor data to assess the state of a plant.

### Example 1

Plant Phytomonitoring

The phytomonitoring method of the present invention is effected by recognizing trend(s) in data collected from a plant and it's environment over a period of time.

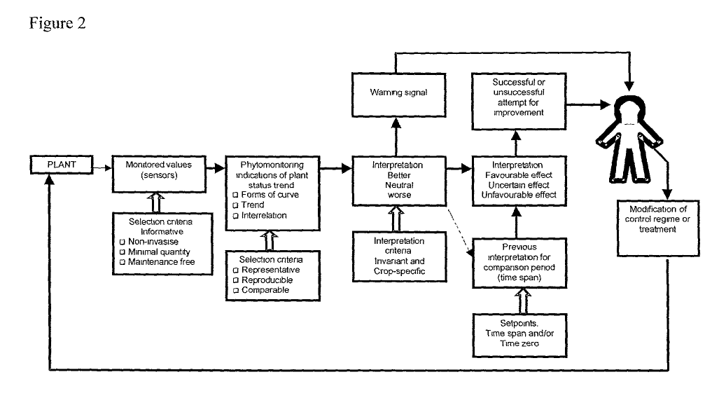

As shown in FIG. 2, such a trend or trends can be graphically presented and used either individually or in combination to assess the plant condition in terms of “better”, “worse” or “no change” (neutral) along a growth period of the plant.

Thus, the present invention allows to express plant and crop performance in relative, qualitative values, rather than absolute values which may not be available or which are difficult to interpret and/or correlate to an actual plant state and which, when collected from a representative plant or plants cannot be accurately utilized to asses the state of a crop.

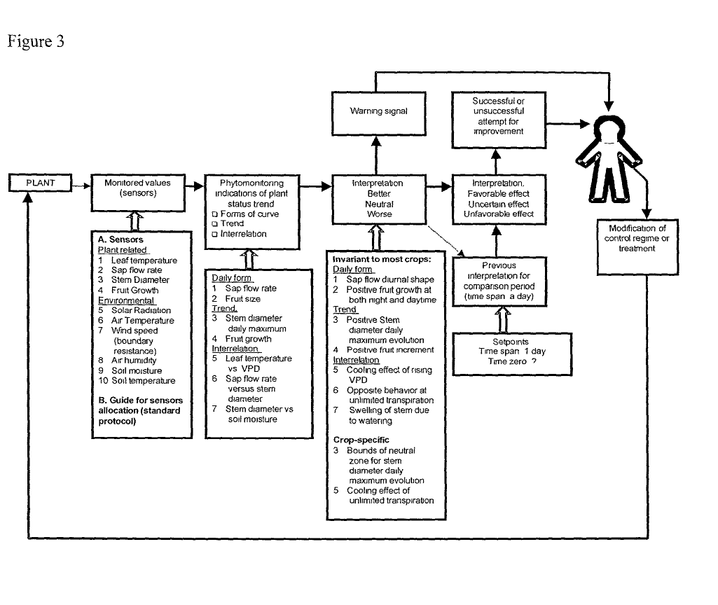

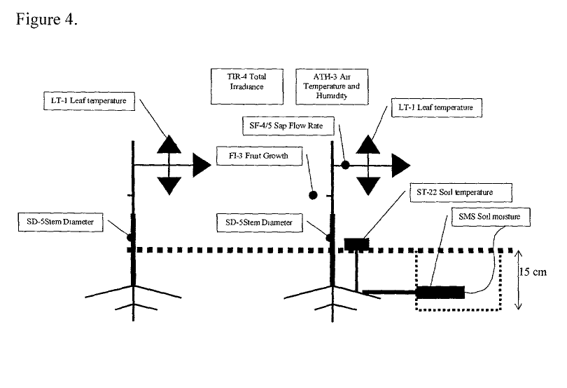

As shown in FIG. 3, data is collected by a set of sensors positioned on a plant and in the environment thereof. The sensors used are selected such that the plant and environmental parameters monitored are informative for detection of both short and long term plant responses to environmental effects. The data collected from these plant and environmental sensors is plotted with respect to time thus enabling the recognition of characterizable trends.

Three general types of trends are recognized. A positive trend, which indicates an improvement in plant state; a neutral trend, which indicates an unchanged plant state or a negative trend which indicates a deterioration in the state of a plant.

For example, a trend in trunk diameter is considered favorable when positive or unfavorable when negative, while a negative trend in sap flow rate is considered as evidence for inhibited transpiration and photosynthesis.

In addition trends in environmental collected data such as vapor pressure can be assessed independently or in combination with plant related trends in order to predict the state of a plant.

When a reversal of a trend is observed, it may be used for comparative analysis of a response of a crop to various changes in environment, such as estimation of crop response to intentional changes in an irrigation or lighting schedule.

Thus, the present invention enables a grower to monitor and predict the state of a plant without having to interpret and/or correlate numerical values but by simply observing trend types in plant and/or environmental collected data. In addition, trend collection and assessment enables a grower to determine the state of a crop by simply monitoring a representative plant or plants.

### Example 2

### Plant and Environmental Sensor Positioning

The sensors utilized by the present invention are positioned according to the following considerations:

Plant sensors:

(i) All of the sensors used are placed on various components of a single plant stem and their power and communications cables are attached to the shoot by an adhesive tape . . .

(ii) The leaf temperature sensor (e.g., LT-1, Phytech Ltd.) is placed on sunlit fully expanded leaf forming a part of the canopy top.

(iii) The sap flow rate sensor (e.g., SF-4, Phytech Ltd.) is placed at the leaf petiole in a position such that the total leaf area above the sensor is less than 50 cm².

(iv) The stem diameter sensor (e.g., SD-5, Phytech Ltd.) is placed upon the lowest internode of the main stem.

Environmental sensors:

(i) The solar radiation sensor (e.g., TIR-4, Phytech Ltd.) is placed over the top of the leaf canopy.

(ii) The combined air temperature and humidity sensor (e.g., ATH-3 Phytech Ltd.) is placed over the top of the leaf canopy.

(iii) The soil moisture sensor (e.g., SMS-1, Phytech Ltd.), is placed in the soil in a hole having the following dimensions: 25-30 cm in diameter and 15-20 cm depth. The sensor(s) are placed horizontally within the hole which is filled up with soil restored to the required compaction. (iv) The soil temperature sensor (e.g., ST-22, Phytech Ltd.) is placed near the roots of the plant in proximity to the soil moisture sensor.

### Example 3

### Collection and Analysis of Sensor Data

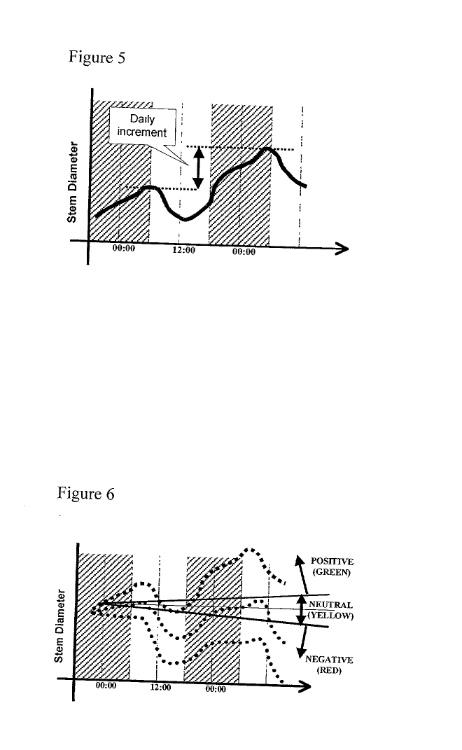

Data pertaining to daily stem variations of a tomato plant was collected over a period of 3 days (FIG. 5).

Stem diameter change is caused by turgidity variations, which are influenced by water balance and osmotic regulation. As shown in FIG. 5, daily changes in stem diameter were observed over the measured time period, which resulted in a net increase in stem diameter. A daily stem diameter maximum is usually measured at predawn value; a daily change in stem diameter is calculated according to a subtraction of two sequential maximums.

FIG. 6 represents a stem diameter line graph generated from data collected from a tomato plant over a period of 2 days. Variations between maximums of the graph represent positive, neutral or negative trends in stem diameter changes.

Such trends are indicative of a plant state and can serve as objective assessment of crop disorders; this enables a grower to undertake certain cultivation steps in order to improve crop production.

For example, a negative trend in stem diameter and/or fruit size is usually considered as an indication for a deterioration in plant state. Observation of such trends requires a change in a growth regimen in order to prevent crop damage and loss.

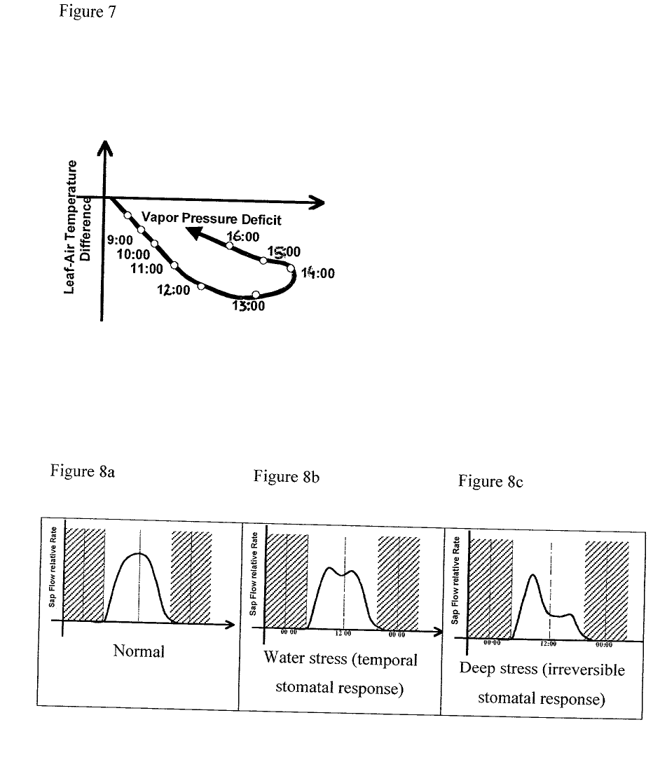

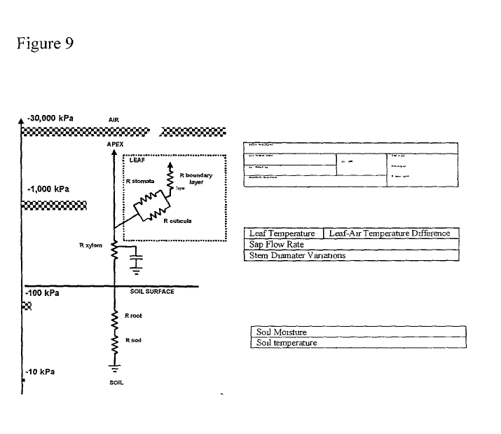

FIG. 7 is an example of plant-environment interaction analysis of leaf air temperature difference as a function of vapor pressure deficit (VPD). As can be seen therein, a loop-like diurnal curve was observed. This curve illustrates that a decrease in leaf air temperature differences can be correlated to an increase in the vapor pressure deficit.

Thus, the trend observed between 8:00 a.m. and 12:00 a.m. indicates unlimited transpiration during this period. Later in the day, at 12:00 a.m., transpiration slowed down probably due to a stomatal response. Such a loop-like trend in a diurnal curve is also typical for plants subjected to water stress.

FIGS. 8a-c represent sap flow rate in a tomato plant over a specific time period of several hours. FIG. 8a represents a line graph typical of a normal/optimal hydration state. When a plant is grown under moderate water stress conditions a temporal stomatal response is observed and the curve changes its shape (FIG. 8b). When the plant is grown under increased water stress conditions which result in an irreversible stomatal response, the curve changes again and a negative trend is formed (FIG. 8c). Such curves of diurnal sap flow rate are typical for clear, sunny days.

Thus, as exemplified in the results section hereinabove a limited set of sensors can be informative and indicative of a plant state. A typical plant sensor set should include a leaf temperature sensor, a sap flow and relative rate sensor and a stem diameter variation sensor.

This set of sensors covers the entire range of short and long term responses of a plant to environmental conditions. Leaf temperature and sap flow rate sensors are mostly responsive to short-term effects for which a typical response time is several minutes. Stem diameter sensor represents the turgidity variations caused by fluctuations of water balance and osmotic regulation and is thus useful for monitoring short to long term effects. Correlation between sap flow rate and stem diameter variations provides important information relating to the short and long term dynamics of a plant-water relationship.

Time plotted curves of sensor data can also be co-plotted with respect to predetermined thresholds.

For example, when using an environmental air temperature sensor positioned at the top of a plant and plotting actual air temperature with respect to predetermined temperature thresholds it is possible to further qualify trends.

FIG. 10 illustrates such an analysis. As shown therein, curve portions which proceed in a direction above the maximal threshold or below the minimal threshold represent negative trends, while curve portions which proceed in reversed direction it is considered a positive trend. Curve portions which remain within the area defined within the thresholds are considered neutral.

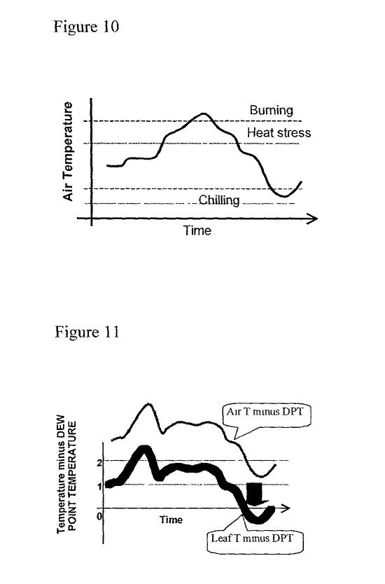

Alternatively, when using a leaf temperature sensor, (FIG. 11) a graph which represents temperature values minus dew point temperature (DPT) can be plotted. In this case, leaf temperature may be lower than air temperature at nighttime due to radiative cooling. At the same time, the lower leaf temperature may cause the appearance of dew on the monitored leaf while the air temperature and humidity are still high.

Analysis of trends in plant related parameters during a predetermined time period is effective when such trends can be associated with a defined plant state.

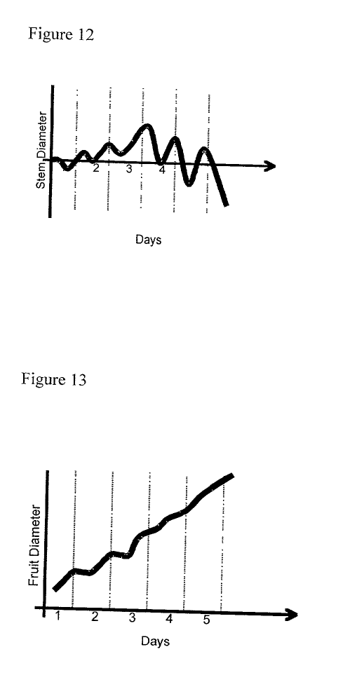

For example, measurement of stem diameter by a stem diameter sensor over time can provide an indication of plant state since stem daily contraction is affected by the water state of a plant. Thus, a general positive trend evolution in stem diameter (FIG. 12) is indicative of normal plant hydration and growth (days 1, 2 and 3), while a negative trend evolution which is associated with simultaneous increase of daily contraction (following the forth day) can be indicative of suboptimal plant hydration.

An additional example of such trend analysis is illustrated by measuring fruit diameter variation, which is also an indication of a plant state (FIG. 13). Data obtained from a tomato fruit over time was utilized to construct a plant state curve. The fruit diameter shrinkage illustrated by the negative trend observed during days 2 and 3 is indicative of a physiological disorder or water stress, while the normal fruit diameter variation illustrated by positive trend of days 4 and 5 indicates normal plant state and ample watering.

### Example 4

### Correlation of Trends

Several characteristics of a plant physiological state can be effectively examined via dynamic trend correlation. Analysis can be effected via:

(i) a correlation between a plant and its environment and/or

(ii) a correlation between two plant-related parameters.

For example, a typical diurnal curve of sap flow relative rate as a function of vapor pressure deficit (Air VPD)can be used to correlate between a plant and its environment.

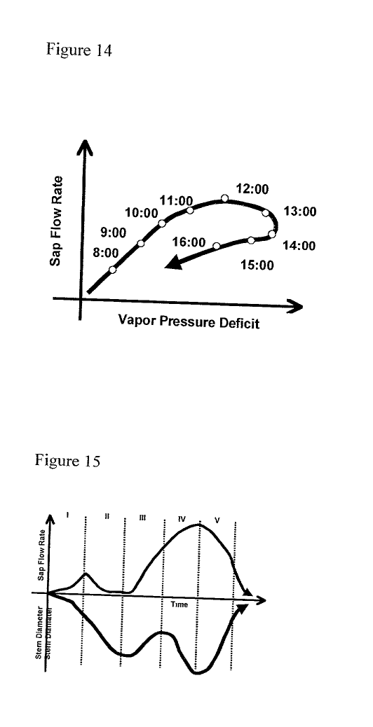

As is shown in FIG. 14, data obtained from a SF-4 Stem Flux Relative Rate Sensor and an ATH-2 air temperature and humidity sensor can be utilized to construct a water state curve. The linear curve observed from 8:00 a.m. until 12:00 a.m. illustrates a positive trend evolution. Such curve behavior is evidence for unlimited transpiration. The loop-like diurnal curve observed from 12:00 a.m. on, is indicative of reduced transpiration which is most likely due to stomatal response. Such a loop-like diurnal curve is also typical for plants subjected to water stress.

An example of a correlation analysis between two plant-related parameters is shown in FIG. 15. These diurnal curves present all possible relationships between sap flow rate and stem diameter.

Graph sections I and IV represent normal a normal increase in transpiration which is associated with natural loss of turgor. Graph section II illustrates water stress conditions which cause the simultaneous reduction of transpiration and turgor. Graph section III represents a restoration of transpiration and turgor following rehydration of the plant. Graph section V represents a typical evening reduction of transpiration and turgor recovery.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of assessing a state of a plant comprising:
(a) collecting data pertaining to at least one plant related parameter over a predetermined time period; and
(b) analyzing said data collected over said predetermined time period to thereby identify a trend in said data over at least a portion of said predetermined time period, said trend being indicative of the state of the plant.

2. The method of claim 1, further comprising the step of correlating said trend to an additional trend derived from data pertaining to an additional plant related parameter collected over said predetermined time period.

3. The method of claim 1, further comprising the step of correlating said trend to at least one environmental parameter data acquired prior to or during said predetermined time period to thereby determine said state of said plant.

4. The method of claim 1, wherein said trend represents a positive change in a value of said at least one plant related parameter, a negative change in said value of said at least one plant related parameter, or no change in said value of said at least one plant related parameter over said at least a portion of said predetermined time period.

5. The method of claim 1, further comprising the step of graphically representing said data pertaining to said at least one plant related parameter over said predetermined time period.

6. The method of claim 1, wherein said data pertaining to said at least one plant related parameter is selected from the group consisting of leaf temperature data, flower temperature data, fruit surface temperature data, stem flux relative rate data, stem diameter variation data, fruit growth rate data, leaf CO2 exchange data and stem elongation rate data.

7. The method of claim 3, wherein said at least one environmental parameter data is selected from the group consisting of air humidity data, air temperature data, solar radiation data, a boundary diffusion layer resistance data, wind speed data, soil moisture data, and soil temperature data.

8. The method of claim 1, wherein said step of collecting data is effected by at least one sensor positioned on, or in proximity to, said plant.

9. The method of claim 1, wherein said step of analyzing said data is effected by a processing unit.

10. A system for assessing a state of a plant comprising:
(a) at least one sensor positioned on, or in proximity to, the plant, said at least one sensor being for collecting data pertaining to at least one plant related parameter; and
(b) a user client being in communication with said at least one sensor, said user client being for receiving and optionally analyzing said data collected from said at least one sensor over a predetermined time period to thereby identify a trend in said data over at least a portion of said predetermined time period, said trend being indicative of the state of said plant.

11. The system of claim 10, wherein said communication between said user client and said at least one sensor is effected via a communication network.

12. The system of claim 10, further comprising a display being for displaying said data collected from said at least one sensor over said predetermined time period.

13. The system of claim 10, further comprising at least one device being in communication with said at least one user client, said device being for modifying said state of said plant.

14. The system of claim 13, wherein said device is selected from the group consisting of an irrigation device, a fertigation device and a climate controller.

15. A method of assessing a state of a crop comprising:
(a) selecting a first plant, said first plant being representative of the crop;
(b) collecting a first set of data pertaining to at least one plant related parameter of said first plant over a predetermined time period; and
(c) analyzing said first set of data collected over said predetermined time period to thereby identify a trend in said first set of data over at least a portion of said predetermined time period, said trend being indicative of a state of said first plant and thus the state of the crop.

16. The method of claim 15, further comprising:
(d) selecting a second plant, said second plant being a reference plant to said first plant;
(e) collecting a second set of data pertaining to at least one plant related parameter of said second plant over said predetermined time period; and
(f) comparing said first set of data and said second set of data to thereby verify that said first plant is representative of said field crop.

17. The method of claim 15, wherein said step of selecting said first plant is effected according to at least one selection criterion.

18. The method of claim 17, wherein said at least one selection criterion is selected from the group consisting of height of a plant, number of leaves, number of fruits, number of flowers, fruit size, and number and length of shoots.

19. The method of claim 16, wherein said step of selecting said second plant is effected according to said at least one selection criterion.

20. The method of claim 15, further comprising the step of correlating said trend to an additional trend derived from data pertaining to an additional plant related parameter collected over said predetermined time period.

21. The method of claim 15, further comprising the step of correlating said trend to at least one environmental parameter data acquired prior to or during said predetermined time period, to thereby determine the state of said first plant and thus the state of said crop.

22. The method of claim 15, wherein said trend represents a positive change in a value of said at least one plant related parameter, a negative change in said value of said at least one plant related parameter, or no change in said value of said at least one plant related parameter over said at least a portion of said predetermined time period.

23. The method of claim 15, wherein said data pertaining to said at least one plant related parameter is selected from the group consisting of leaf temperature data, flower temperature data, fruit surface temperature data, stem flux relative rate data, stem diameter variation data, fruit growth rate data, leaf CO2 exchange data and stem elongation rate data.

24. The method of claim 21, wherein said at least one environmental data is selected from the group consisting of air humidity data, air temperature data, solar radiation data, a boundary diffusion layer resistance data, wind speed data, soil moisture data, and a soil temperature data.

25. The method of claim 15, wherein said step of collecting said first set of data is effected by at least one sensor positioned on, or in proximity to, said first plant.

26. The method of claim 16, wherein step (e) is effected by at least one sensor positioned on, or in proximity to, said second plant.

27. The method of claim 15, wherein step (c) is effected by processing unit.

28. A method of assessing the state of a crop comprising:
(a) co-cultivating a first plant with a crop of a second plant, said first plant being more sensitive to a change in at least one environmental factor or an infection by a pathogen than said second plant; and
(b) monitoring at least one parameter associated with said first plant to thereby assess the state of said crop.
